(19) United States
(12) Patent Application Publication
(10) Pub. No.: US 2024/0357589 A1
(43) Pub. Date: Oct. 24, 2024

(54) UL HARQ OPERATION ENHANCEMENT FOR POWER ENHANCEMENT/SAVING

(71) Applicant: MEDIATEK Inc., Hsinchu City (TW)

(72) Inventors: Tse-Wei LIN, Hsinchu City (TW); Shih-Ping LIANG, Hsinchu City (TW); Jia-Shi LIN, Hsinchu City (TW)

(21) Appl. No.: 18/640,291

(22) Filed: Apr. 19, 2024

Related U.S. Application Data
(60) Provisional application No. 63/496,979, filed on Apr. 19, 2023.

(51) Int. Cl. H04W 72/1273; H04L 1/08; H04L 5/00; H04W 76/28

(52) U.S. Cl. CPC H04W 72/1273; H04L 1/08; H04L 5/0053; H04W 76/28

(57) ABSTRACT

An UL HARQ operation enhancement for power enhancement/saving is provided. A controlling method for the user equipment includes the following steps. A waiting section for receiving a retransmission (RETX) grant signal or a Negative Acknowledgement (NACK) signal is set. Whether the user equipment receives a Acknowledge (ACK) signal is determined. After the ACK signal is received, time or count is counted. Whether the waiting section is reached is determined. After the waiting section is reached, monitoring Physical Downlink Control Channel (PDCCH) and/or Physical Hybrid ARQ Indicator Channel (PHICH) is stopped.

This application claims the benefit of U.S. Provisional application Ser. No. 63/496,979, filed Apr. 19, 2023, the disclosure of which is incorporated by reference herein in its entirety.

### TECHNICAL FIELD

The disclosure relates in general to UL HARQ operation enhancement for power enhancement/saving.

### BACKGROUND

Along with the development of the communication technology, varied communication devices are invented. For receiving data from the network or transmitting data to the network, the communication device should frequently monitor the channel.

However, frequent monitoring the channels will result in rapid power consumption. How to reduce power consumption has become the most important research and development direction of the communication technology.

### SUMMARY

The disclosure is directed to UL HARQ operation enhancement for power enhancement/saving. An uplink Hybrid Automatic Repeat Request (UL HARQ) operation enhancement is used for the user equipment, so that not all of the HARQ transmission responses (ACK, NACK RETX Grant) are monitored. Therefore, the power consumption could be greatly saved.

According to one embodiment, a controlling method for a user equipment which is a communication device is provided. The controlling method for the user equipment includes the following steps. A waiting section for receiving a retransmission (RETX) grant signal or a Negative Acknowledgement (NACK) signal is set. Whether the user equipment receives a Acknowledge (ACK) signal is determined. After the ACK signal is received, time or count is counted. Whether the waiting section is reached is determined. After the waiting section is reached, monitoring Physical Downlink Control Channel (PDCCH) and/or Physical Hybrid ARQ Indicator Channel (PHICH) is stopped.

According to another embodiment, a modem chip equipped in a user equipment which is a communication device is provided. The modem chip is used to: set a waiting section for receiving a retransmission (RETX) grant signal or a Negative Acknowledgement (NACK) signal; determine whether the user equipment receives a Acknowledge (ACK) signal; count time or counter, after the ACK signal is received; determine whether the waiting section is reached; stop monitoring Physical Downlink Control Channel (PDCCH) and/or Physical Hybrid ARQ Indicator Channel (PHICH), after the waiting section is reached.

According to an alternative embodiment, a user equipment, which is a communication device is provided. The user equipment includes a wireless communication module and a modem chip. The modem chip is connected to the wireless communication module. The modem chip is used to: determine set a waiting section for receiving a retransmission (RETX) grant signal or a Negative Acknowledgement (NACK) signal; determine whether the user equipment receives a Acknowledge (ACK) signal; count time or counter, after the ACK signal is received; determine whether the waiting section is reached; and stop monitoring Physical Downlink Control Channel (PDCCH) and/or Physical Hybrid ARQ Indicator Channel (PHICH), after the waiting section is reached.

### BRIEF DESCRIPTION OF THE DRAWINGS

FIG. 1 shows a Long-Term Evolution (LTE) uplink Hybrid Automatic Repeat Request (UL HARQ) mechanism according to one embodiment of the present disclosure.

FIG. 2 shows the LTE UL HARQ mechanism according to another embodiment of the present disclosure.

FIG. 3 shows the LTE UL HARQ mechanism according to another embodiment of the present disclosure.

FIG. 4 shows the LTE UL HARQ mechanism according to another embodiment of the present disclosure.

FIG. 5 shows the LTE UL HARQ mechanism according to another embodiment of the present disclosure.

FIG. 6 shows the LTE UL HARQ mechanism according to another embodiment of the present disclosure.

FIG. 7 illustrates the times to monitor the RETX grant signal according to one embodiment of the present disclosure.

FIG. 8 illustrates a DRX active time according to one embodiment of the present disclosure.

FIG. 9 illustrates the network environment suitable for enhancing the UL HARQ operation according to one embodiment of the present disclosure.

FIG. 10 illustrate an UL HARQ operation enhancement according to another embodiment of the present disclosure.

FIG. 11 shows a block diagram of the user equipment according to one embodiment of the present disclosure.

FIG. 12 shows a flowchart of a controlling method for the user equipment which is a communication device according to one embodiment of the present disclosure.

FIG. 13 shows a state machine diagram of the user equipment according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

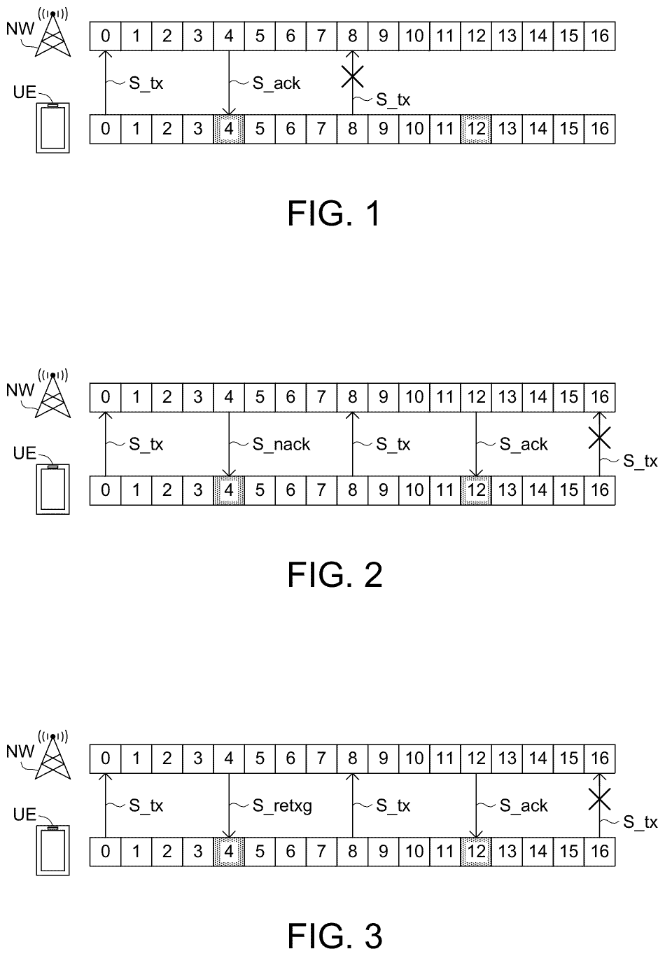

Please refer to FIG. 1, which shows a Long-Term Evolution (LTE) uplink Hybrid Automatic Repeat Request (UL HARQ) mechanism according to one embodiment of the present disclosure. After the user equipment UE which is a communication device transmits a transmission signal S_tx to the network NW, the network NW may return an Acknowledge (ACK) signal S_ack. S_tx could be new transmission or retransmission. After receiving the ACK signal S_ack, the user equipment UE would stop retransmitting transmission signal S_tx.

Please refer to FIG. 2, which shows the LTE UL HARQ mechanism according to another embodiment of the present disclosure. After the user equipment UE transmits a transmission signal S_tx to the network NW, the network NW may return a Negative Acknowledge (NACK) signal S_nack. After receiving the NACK signal S_nack, the user equipment UE would retransmit the transmission signal S_tx.

Please refer to FIG. 3, which shows the LTE UL HARQ mechanism according to another embodiment of the present disclosure. After the user equipment UE transmits a transmission signal S_tx to the network NW, the network NW may return a retransmission (RETX) grant signal S_retxg. After receiving the RETX signal S_retxg, the user equipment UE would retransmit the transmission signal S_tx.

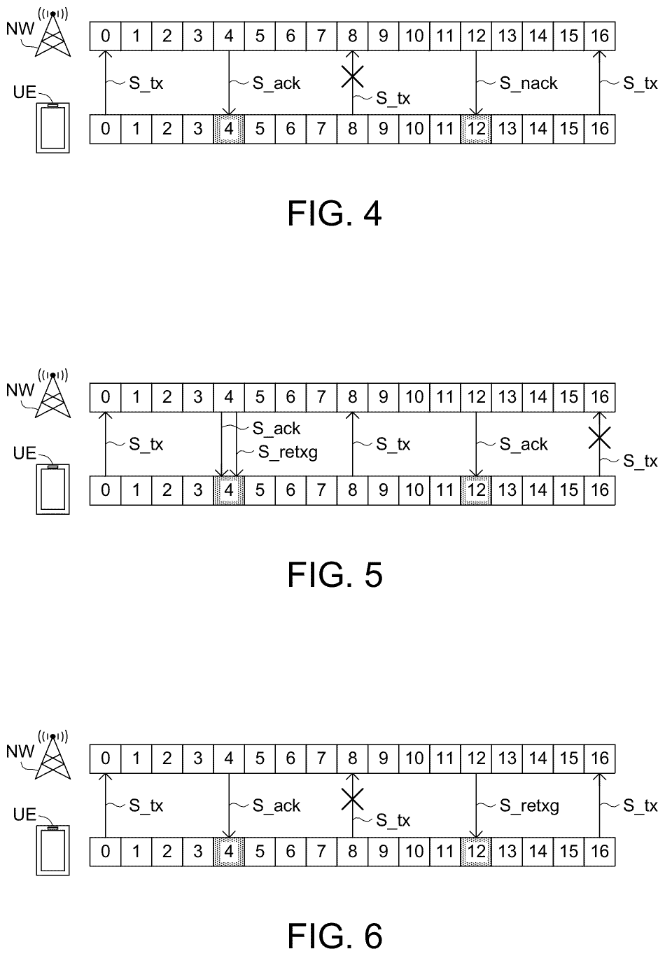

Please refer to FIG. 4, which shows the LTE UL HARQ mechanism according to another embodiment of the present disclosure. After the user equipment UE transmits a transmission signal S_tx to the network NW, the network NW may return an ACK signal S_ack. After receiving the ACK signal S_ack, the user equipment UE would stop retransmitting the transmission signal S_tx. However, the ACK signal S_ack does not mean that the transmission signal S_tx is successfully accepted by the network NW. So, at the next time, the network NW may return the NACK signal S_nack to the user equipment UE, then the user equipment UE needs to retransmit the transmission signal S_tx.

Please refer to FIG. 5, which shows the LTE UL HARQ mechanism according to another embodiment of the present disclosure. After the user equipment UE transmits a transmission signal S_tx to the network NW, the network NW may return an ACK signal S_ack and a RETX grant signal S_retxg. After receiving the RETX grant signal S_retxg, the user equipment UE would retransmit the transmission signal S_tx. Next, the network NW may return the ACK signal S_ack, then the user equipment UE would stop retransmitting the transmission signal S_tx.

Please refer to FIG. 6, which shows the LTE UL HARQ mechanism according to another embodiment of the present disclosure. After the user equipment UE transmits a transmission signal S_tx to the network NW, the network NW may return an ACK signal S_ack. After receiving the ACK signal S_ack, the user equipment UE would stop retransmitting the transmission signal S_tx. However, the ACK signal S_ack does not mean that the transmission signal S_tx is successfully accepted by the network NW. So, at the next time, the network NW may return a RETX grant signal S_retxg to the user equipment UE, then the user equipment UE needs to retransmit the transmission signal S_tx.

When the user equipment UE transmits the transmission signal S_tx to the Network NW, the Network NW returns a downlink control information (DCI) signal S_dci, such as the RETX grant signal S_retxg, or a HARQ feedback signal, such as the ACK signal S_ack or the NACK signal S_nack. Even if the user equipment UE receives the ACK signal S_ack, the user equipment UE still needs to monitor whether the NACK signal S_nack or the RETX grant signal S_retxg is returned.

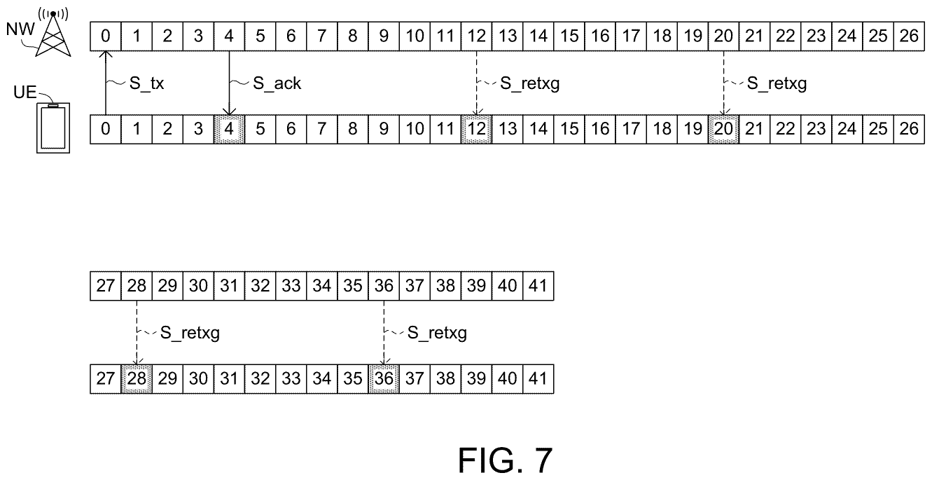

For example, please refer to FIG. 7, which illustrates the times to monitor the RETX grant signal S_retxg according to one embodiment of the present disclosure. After receiving the ACK signal S_ack, the user equipment UE need to monitor whether the RETX grant signal S_retxg (or the NACK signal S_nack) is returned before the HARQ closes.

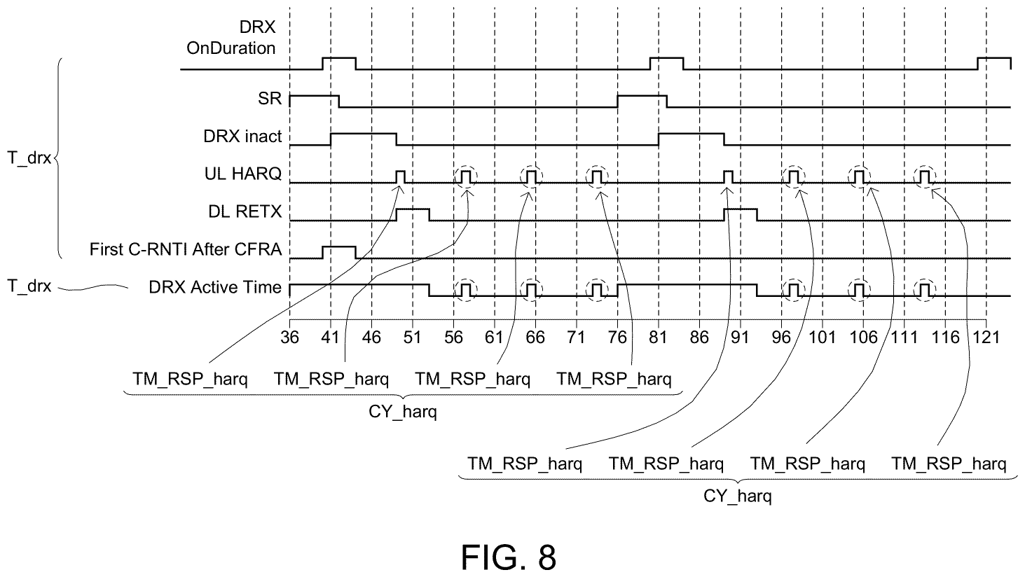

Please refer to FIG. 8, which illustrates a DRX active time T_drx according to one embodiment of the present disclosure. The user equipment UE needs to monitor the Physical Downlink Control Channel (PDCCH) during the DRX active time T_drx. The DRX active time T_drx is defined as 36.321. For example, when a DRX cycle is configured, the Active Time includes the time while:
onDurationTimer or drx-InactivityTimer or drx-RetransmissionTimer or drx-RetransmissionTimerShortTTI or drx-ULRetransmissionTimer or drx-ULRetransmissionTimerShortTTI or mac-ContentionResolutionTimer is running; or
a Scheduling Request is sent on PUCCH/SPUCCH and is pending; or
an uplink grant for a pending HARQ retransmission can occur and there is data in the corresponding HARQ buffer for synchronous HARQ process; or
a PDCCH indicating a new transmission addressed to the C-RNTI of the MAC entity has not been received after successful reception of a Random Access Response for the preamble not selected by the MAC entity; or
mpdcch-UL-HARQ-ACK-FeedbackConfig is configured and repetitions within a bundle are being transmitted according to UL_REPETITION_NUMBER. The UL HARQ cycle CY_harq includes a plurality of HARQ transmission responses TM_RSP_harq.

The NACK signal S_nack or the RETX grant signal S_retxg may be returned at the HARQ transmission responses TM_RSP_harq, so the user equipment UE must be waked up at the HARQ transmission responses TM_RSP_harq to monitor whether the NACK signal S_nack or the RETX grant signal S_retxg is returned.

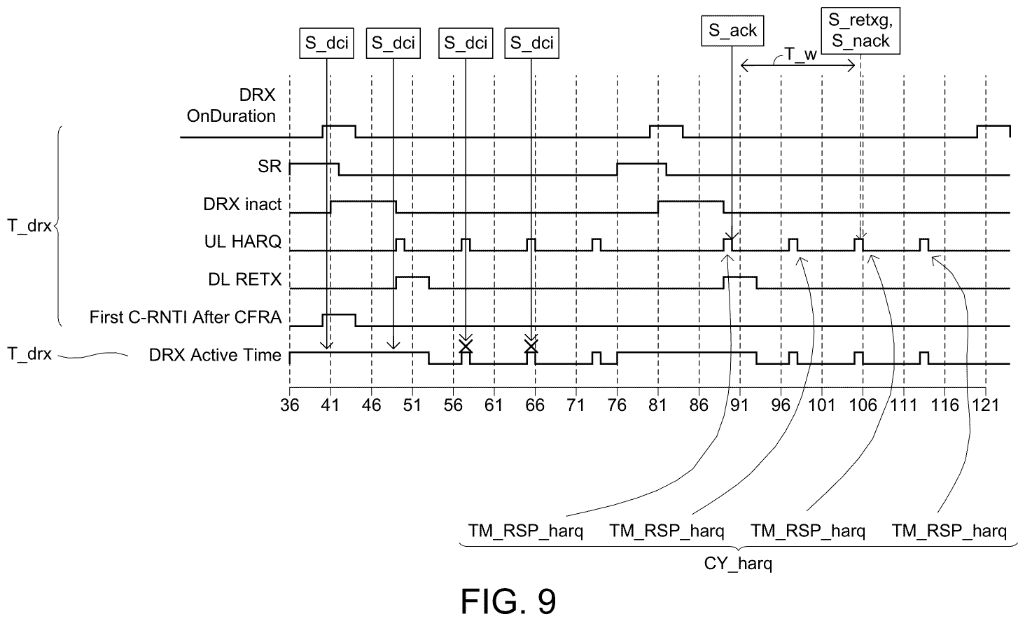

Please refer to FIG. 9, which illustrates the network environment suitable for enhancing the UL HARQ operation according to one embodiment of the present disclosure. In FIG. 9, the user equipment UE receives the signal S_dci only within the DRX active time T_drx defined by 36.321, excluding the DRX active time T_drx only triggered by UL HARQ retransmission opportunity. In this network environment, the user equipment UE would receive the ACK signal S_ack, the NACK signal S_nack and the RETX grant signal S_retxg at the HARQ transmission responses TM_RSP_harq. Therefore, when the user equipment UE receives the ACK signal S_ack, the user equipment UE may receive the RETX grant signal S_retxg or the NACK signal S_nack after a waiting section T_w. The waiting section T_w could be defaulted or obtained by training. Waiting section T_W could be the waiting time for TX response or the number of times for TX response. In FIG. 9, the waiting section T_w is, for example, two HARQ transmission responses TM_RSP_harq. In another embodiment, the waiting section T_w is, for example, one HARQ transmission response TM_RSP_harq. In another embodiment, the waiting section T_w is, for example, zero HARQ transmission response TM_RSP_harq.

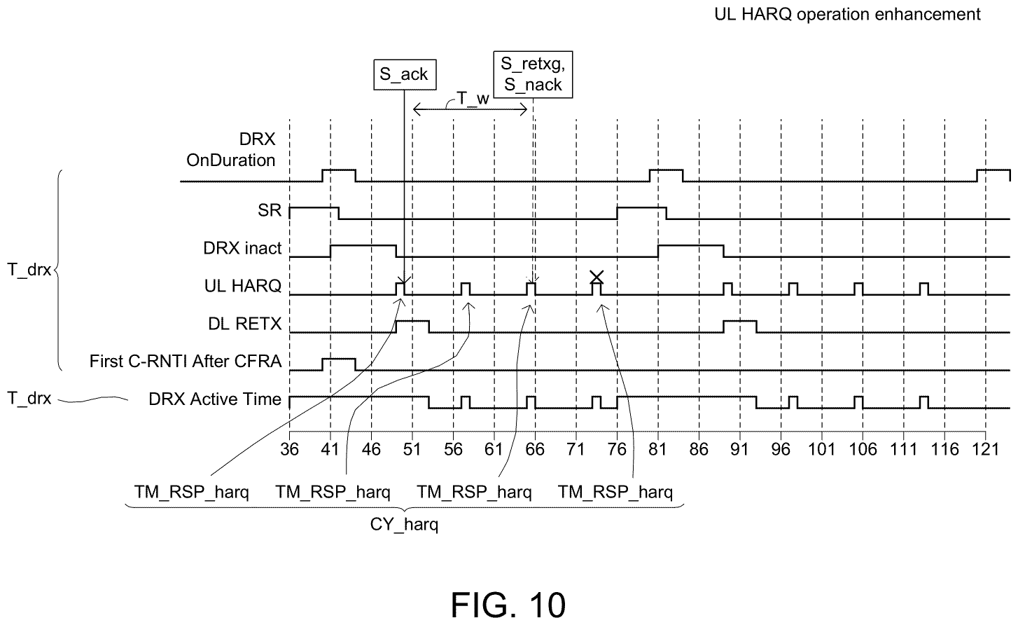

Please refer to FIG. 10, which illustrates an UL HARQ operation enhancement according to one embodiment of the present disclosure. In case of enabling the UL HARQ operation enhancement, when the user equipment UE receives the ACK signal S_ack, the user equipment UE would wait the RETX grant signal S_retxg or the NACK signal S_nack for the waiting section T_w only. In FIG. 10, the waiting section T_w is, for example, two HARQ transmission responses TM_RSP_harq. That is to say, the user equipment UE is waked up (not limited) at the first HARQ transmission response TM_RSP_harq and the second HARQ transmission response TM_RSP_harq after receiving the ACK signal S_ack. But, the user equipment UE is not waked up at the third HARQ transmission response TM_RSP_harq after receiving the ACK signal S_ack. That is to say, in the UL HARQ cycle CY_harq, the user equipment UE is not waked up for all of the HARQ transmission responses TM_RSP_harq. In another embodiment, the waiting section T_w is, for example, one HARQ transmission response TM_RSP_harq. In another embodiment, the waiting section T_w is, for example, zero HARQ transmission response TM_RSP_harq. Therefore, the power consumption could be greatly saved. In this disclosure, monitoring the HARQ transmission response TM_RSP_harq is not limited to the manner of waking up, any other manners could be used.

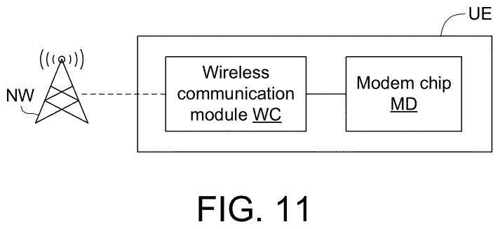

Please refer to FIG. 11, which shows a block diagram of the user equipment UE according to one embodiment of the present disclosure. The user equipment UE includes a wireless communication module WC and a modem chip MD. The modem chip MD is connected to the wireless communication module WC. The user equipment UE could perform the UL HARQ operation enhancement illustrated as above via a controlling method. The controlling method is illustrated via a flowchart.

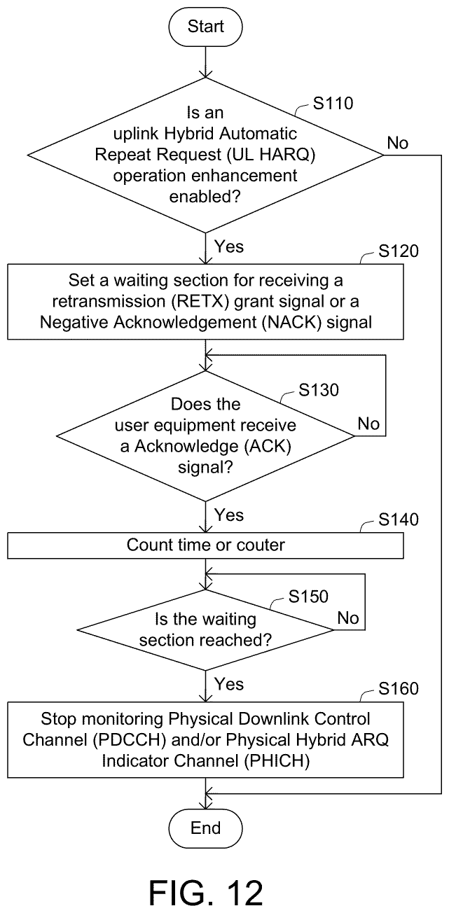

Please refer to FIG. 12, which shows a flowchart of a controlling method for the user equipment UE which is a communication device according to one embodiment of the present disclosure. The controlling method for the user equipment UE includes steps S110 to S160.

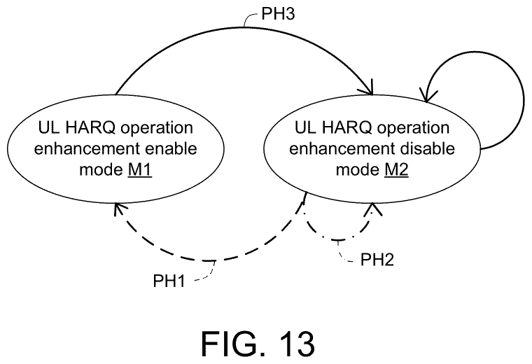

In the step S110, whether the UL HARQ operation enhancement is enabled is determined by the modem chip MD of the user equipment UE. Please refer to FIG. 13, which shows a state machine diagram of the user equipment UE according to one embodiment of the present disclosure. The user equipment UE has an UL HARQ operation enhancement enable mode M1 and an UL HARQ operation enhancement disable mode M2. The user equipment UE may be switched from the UL HARQ operation enhancement disable mode M2 to the UL HARQ operation enhancement enable mode M1 through the path PH1 according to the following condition(s)(not limited): A predetermined quantity of DCI signal S_dci is received within the DRX active time T_drx; and/or the waiting section T_w is obtained by default setting or training; and/or other conditions. In one embodiment, the DRX active time T_drx does not include the active time due to the retransmission (RETX) grant signal. In another embodiment, even the predetermined quantity of DCI signal S_dci is received within the DRX active time T_drx, when the UE receive the DCI during DRX active time which only triggered by the retransmission (RETX) grant signal, then the UL HARQ operation enhancement would not be enabled.

The user equipment UE is trained the waiting section T_w through the path PH2. The user equipment UE may be switched from the UL HARQ operation enhancement enable mode M1 to the UL HARQ operation enhancement disable mode M2 through the path PH3, if the network environment is not suitable to perform the UL HARQ operation enhancement.

If the UL HARQ operation enhancement is enabled, the process proceeds to the step S120.

In the step S120, the modem chip MD of the user equipment UE sets the waiting section T_w for receiving the RETX grant signal S_retxg or the NACK signal S_nack. The waiting section T_w could be trained in advance; or, the waiting section T_w could be default.

Next, in the step S130, the modem chip MD of the user equipment UE determines whether the user equipment UE receives the ACK signal S_ack. If the user equipment UE receives the ACK signal S_ack, the process proceeds to the step S140.

Afterwards, in the step S140, the modem chip MD of the user equipment UE counts time or counter.

Then, in the step S150, the modem chip MD of the user equipment UE determines whether the waiting section T_w is reached. If the waiting section T_w is reached, the process proceeds to the step S160. In one embodiment, if the NACK signal S_nack or the RETX grant signal S_retxg is received, the time or the counter is reset and counted again.

In the step S160, the modem chip MD stops monitoring Physical Downlink Control Channel (PDCCH) and/or Physical Hybrid ARQ Indicator Channel (PHICH). In another embodiment, after the waiting section is reached and the network does not send the Negative acknowledgement NACK signal or the retransmission (RETX) grant signal to the user equipment (UE), monitoring the Physical Downlink Control Channel (PDCCH) and/or Physical Hybrid ARQ Indicator Channel (PHICH) is stopped.

Based on the controlling method described above, in the UL HARQ cycle CY_harq, not all of the HARQ transmission responses TM_RSP_harq are monitored. For example, at least one of the HARQ transmission responses TM_RSP_harq is not monitored. Therefore, the power consumption could be greatly saved. In one embodiment, if the NACK signal S_nack is still received from the network NW, all of the HARQ transmission responses TM_RSP_harq would be monitored, before HARQ close.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A controlling method for a user equipment which is a communication device, comprising:
setting a waiting section for receiving a retransmission (RETX) grant signal or a Negative Acknowledgement (NACK) signal;
determining whether the user equipment receives a Acknowledge (ACK) signal;
counting time or counter, after the ACK signal is received;
determining whether the waiting section is reached; and
stopping monitoring Physical Downlink Control Channel (PDCCH) and/or Physical Hybrid ARQ Indicator Channel (PHICH), after the waiting section is reached.

2. The controlling method for the user equipment according to claim 1, wherein the waiting section for receiving the RETX grant signal or the NACK signal is trained in advance.

3. The controlling method for the user equipment according to claim 1, wherein the waiting section for receiving the RETX grant signal or the NACK signal is default.

4. The controlling method for the user equipment according to claim 1, wherein the waiting section for receiving the RETX grant signal or the NACK signal is two HARQ transmission responses.

5. The controlling method for the user equipment according to claim 1, wherein the waiting section for receiving the RETX grant signal or the NACK signal is one HARQ transmission response.

6. The controlling method for the user equipment according to claim 1, wherein the waiting section for receiving the RETX grant signal or the NACK signal is zero HARQ transmission response.

7. The controlling method for the user equipment according to claim 1, wherein in a UL HARQ cycle, one of a plurality of HARQ transmission responses is not monitored.

8. The controlling method for the user equipment according to claim 1, wherein in a UL HARQ cycle, not all of a plurality of HARQ transmission responses are monitored.

9. The controlling method for the user equipment according to claim 1, wherein in a UL HARQ cycle, the user equipment is not waked up for all of a plurality of HARQ transmission responses.

10. The controlling method for the user equipment UE according to claim 1, wherein the DRX active time includes the time while:
onDurationTimer or drx-InactivityTimer or drx-RetransmissionTimer or drx-RetransmissionTimerShortTTI or drx-ULRetransmissionTimer or drx-ULRetransmissionTimerShortTTI or mac-ContentionResolutionTimer is running; or
a Scheduling Request is sent on PUCCH/SPUCCH and is pending; or
an uplink grant for a pending HARQ retransmission can occur and there is data in the corresponding HARQ buffer for synchronous HARQ process; or
a PDCCH indicating a new transmission addressed to the C-RNTI of the MAC entity has not been received after successful reception of a Random Access Response for the preamble not selected by the MAC entity; or
mpdcch-UL-HARQ-ACK-FeedbackConfig is configured and repetitions within a bundle are being transmitted according to UL_REPETITION_NUMBER.

11. A modem chip equipped in a user equipment which is a communication device, wherein the modem chip is used to:
set a waiting section for receiving a retransmission (RETX) grant signal or a Negative Acknowledgement (NACK) signal;
determine whether the user equipment receives a Acknowledge (ACK) signal;
count time or counter, after the ACK signal is received;
determine whether the waiting section is reached; and
stop monitoring Physical Downlink Control Channel (PDCCH) and/or Physical Hybrid ARQ Indicator Channel (PHICH), after the waiting section is reached.

12. The modem chip equipped in the user equipment according to claim 11, wherein the waiting section for receiving the RETX grant signal or the NACK signal is trained in advance.

13. The modem chip equipped in the user equipment according to claim 11, wherein the waiting section for receiving the RETX grant signal or the NACK signal is default.

14. The modem chip equipped in the user equipment according to claim 11, wherein the waiting section for receiving the RETX grant signal or the NACK signal is two HARQ transmission responses.

15. The modem chip equipped in the user equipment according to claim 11, wherein the waiting section for receiving the RETX grant signal or the NACK signal is one HARQ transmission response.

16. The modem chip equipped in the user equipment according to claim 11, wherein the waiting section for receiving the RETX grant signal or the NACK signal is zero HARQ transmission response.

17. The modem chip equipped in the user equipment according to claim 11, wherein in a UL HARQ cycle, one of a plurality of HARQ transmission responses is not monitored.

18. The modem chip equipped in the user equipment according to claim 11, wherein in a UL HARQ cycle, not all of a plurality of HARQ transmission responses are monitored.

19. The modem chip equipped in the user equipment according to claim 11, wherein in a UL HARQ cycle, the user equipment is not waked up for all of a plurality of HARQ transmission responses.

20. A user equipment, which is a communication device, wherein the user equipment comprises:
a wireless communication module;
a modem chip, connected to the wireless communication module, wherein the modem chip is used to:
set a waiting section for receiving a retransmission (RETX) grant signal or a Negative Acknowledgement (NACK) signal;
determine whether the user equipment receives a Acknowledge (ACK) signal;
count time or counter, after the ACK signal is received;
determine whether the waiting section is reached; and
stop monitoring Physical Downlink Control Channel (PDCCH) and/or Physical Hybrid ARQ Indicator Channel (PHICH), after the waiting section is reached.
